(19) United States
(12) Patent Application Publication
(10) Pub. No.: US 2026/0056086 A1
(43) Pub. Date: Feb. 26, 2026

(54) DEVICE AND METHOD FOR DETERMINING A STATE OF AN OPTICAL SYSTEM FOR AN ENDOSCOPE

(71) Applicant: KARL STORZ SE & Co. KG, Tuttlingen (DE)

(72) Inventor: Klaus Brüderle, Radolfzell (DE)

(73) Assignee: KARL STORZ SE & Co. KG, Tuttlingen (DE)

(21) Appl. No.: 19/302,782

(22) Filed: Aug. 18, 2025

(30) Foreign Application Priority Data
Aug. 19, 2024 (DE) 10 2024 123 656.6

(51) Int. Cl. G01M 11/00; G02B 27/00; G06T 7/80

(52) U.S. Cl. CPC G01M 11/30; G02B 27/0006; G06T 7/80; G06T 2207/10068

(57) ABSTRACT

The invention provides a device and a system for determining a state of an optical system for an endoscope. The device comprises: an input interface configured to receive image data acquired by means of the optical system; a computing device configured to implement at least one evaluation module configured to determine an entire optical flow of the obtained image data, to identify on this basis at least one image flow vector, and, if at least two different image flow vectors have been identified, to determine on this basis at least one state of the optical system; and an output interface which is configured to generate an output signal which comprises an item of information about the determined at least one state of the optical system.

### CROSS-REFERENCE TO RELATED APPLICATIONS

The present application claims the benefit of German Patent Application 10 2024 123 656.6 filed on Aug. 19, 2024, having a title of, “Kontinuierliche Erfassung der Objektiv Qualität unserer Kameras und Endoskope” (“Device and method for determining a state of an optical system for an endoscope”) and is incorporated herein by reference in its entirety.

### TECHNICAL FIELD

The present invention relates to systems and methods for determining a state of an optical system for an endoscope. The state can be an impairment of the optical system, for example damage to or contamination of the optical system.

### BACKGROUND

Endoscopes have become indispensable amongst surgical instruments. They enable a surgeon to gain detailed and accurate knowledge of a surgical site without having to open the site completely. A problem-free state of the endoscope, particularly of the optical system of the endoscope, is therefore of great importance, since impairments of the optical system can make the surgeon's work more difficult or error prone.

In some cases, it is not clear to the surgeon whether a graphic image presented by the imaging system is accurate or whether it is due, in whole or in part, to an impairment of the optical system of the endoscope. For example, the optical system could be dirty or damaged.

### SUMMARY

To overcome the above limitations and advance the state of the art, the following description is provided to, among other things, enable a reliable determination of the state of an optical system of an endoscope. This is achieved with respect to the disclosed embodiments and/or aspects and as recited by the claims. Certain embodiments herein describe image data acquired by an optical system. It should be understood that “image data” refers to visual elements, such as pixels, pixel values (e.g., saturation, color, etc.), observed shapes, observed motion, visual artifacts, and the like, which may be captured by a camera, such as a camera of an endoscope. Unless expressly stated otherwise, “image data” does not refer to metadata, file type, image dimensions, or other descriptors of the image.

In one embodiment, a device is provided for determining a state of an optical system for an endoscope, the device comprises: an input interface configured to receive image data acquired by the optical system; a computing device configured to implement at least one evaluation module configured to determine an overall optical flow (or main optical flow) of the image data obtained, to identify at least one image flow vector based thereon, and, if at least two different image flow vectors have been identified (optionally: and a global image flow has also been determined), to determine at least one state of the optical system based thereon; and an output interface which is configured to generate an output signal which comprises an item of information about the determined at least one state of the optical system.

With respect to certain embodiments, reference to optical image flow vectors are to main vectors or dominant optical image flow vectors. In other embodiments, such as when optical image flow vectors are described with respect to a portion of all optical image flow vectors, then the portion thereof are the optical image flow vectors.

In another embodiment, the optical flow of image data of an endoscope is evaluated in order to determine the current state of the endoscope, in particular, the state of the optical system of the endoscope.

In another embodiment, an evaluation module is provided that checks whether a global image flow is present (e.g., whether image flow vectors in a specific sequence of image data are the result of travel or movement of the optical system (as a whole)), rather than, for example, a movement of individual objects or structures within an image acquired by the optical system. For this purpose, for example, the evaluation module can ascertain how many non-vanishing (i.e. different from the zero vector) image flow vectors (in particular main vectors, or dominant optical image flow vectors) are present, and only starting from a certain threshold value of Y % of pixels (or regions of the image data) with a non-vanishing image flow vector can it be concluded that a global image flow is present. When determining the at least one state, it can be provided that an impaired state of the optical system can be inferred only in those image data in which a global image flow was previously detected. The threshold Y % for detecting a global image flow can be, for example, 40%, 50%, 60%, 70%, 80%, 90%, 95%, 98%, or the like.

The threshold Y % can be fixed or variable. A variable threshold Y % may be adjusted based on at least one of the previously determined states. For example, if it has already been determined in the past that a certain optical system is impaired to such an extent that only 90% of the pixels are acquiring the actual image of the subject, while the rest do not (e.g., no image, image of damaged optics, optical artifact, etc.) the threshold Y % can be lowered accordingly, such as to be scaled based on the number of unimpaired pixels. For example, if the initial threshold is set to Y %=80% and only 90% of the pixels are unimpaired or reliable, a new, adjusted threshold can be set to 90%*80%=72%.

The optical system comprises various components, which may include a lens system and/or a plurality of optical conductors (e.g. glass fibers) which transmit an image optically acquired by the lens system as light signals to a processing device, such as the computing device described herein. The lens system may comprise one or more lenses.

Aspects of certain embodiments comprise an endoscope or a portion of an endoscope, in particular, an optical system of an endoscope. The state of the endoscope or optical system will be determined as described herein.

Although some functions are described here, above and below, as being performed by “devices,” “interfaces,” or “modules,” it is to be understood that this does not necessarily mean that such devices, interfaces, or modules are provided as separate units. In cases in which one or more devices or a part thereof are provided as in whole or in part as software, the devices can be implemented by sections or snippets of program code, which can differ from one another but can also be interwoven with one another.

Similarly, in the case in which one or more devices, interfaces, or modules are provided as hardware, the functions of one or more devices, interfaces, or modules may be provided by one and the same hardware component, or the functions of one device, interface, or module, or the functions of multiple devices, interfaces, or modules may be distributed among multiple hardware components that do not necessarily correspond one-to-one to the devices, interfaces, or modules. For this reason, any device, system, method, etc. that has all the features and functions attributed to a particular device and/or interface and/or module is to be understood as constituting, including, or implementing the device and/or interface and/or module.

In certain embodiments, all devices, interfaces, or modules are implemented by program code that is executed by a computing device.

The computing device can be implemented as a device or means for computing, in particular for executing an item of software, application, or algorithm. For example, the computing device can comprise at least one processor, such as at least one central processor, CPU, and/or at least one graphics processor, GPU, and/or at least one field programmable gate array, FPGA, and/or at least one application-specific integrated circuit, ASIC, and/or any combination of the foregoing. The computing device can further comprise a RAM memory operatively connected to the at least one processor and/or a non-volatile memory operatively connected to the at least one processor and/or the RAM memory. The computing device can be partially and/or fully implemented in a local device and/or partially and/or fully implemented in a remote system, such as a cloud computing platform.

In another embodiment, computer-implemented method is disclosed for determining a state of an optical system for an endoscope. The method comprises: obtaining image data acquired by the optical system; determining an overall optical flow (or main optical flow) in the obtained image data; identifying at least one image flow vector in the determined overall optical flow; and, if at least two different image flow vectors have been identified (optionally; and if a global image flow has also been detected): determining, based on the at least two different identified image flow vectors, at least one state of the optical system.

It should be appreciated that the image data (e.g., objects or portions of objects captured by the camera) have the same flow vector if all the image data moves in parallel (e.g., camera is moving left, right, up, down, etc.), radially inward to a common location (e.g., camera is moving backwards), radially outward from a common (e.g., camera is moving forwards), rotation about a common location (e.g., camera is being rotated), or combinations thereof. Therefore, it should be appreciated, that image vectors may be considered the same when they are identical (i.e., parallel) or common, such as, radially convergent, radially divergent, rotationally co-aligned, or combinations thereof) and image vectors are different when not the same or common. As a result, image data that does not have the same flow vectors may be identified as not being a feature of the subject being imaged and/or identified as a defect or contamination of the optical system.

In another embodiment, image flow vectors may be determined by relevant motion averaged over time. For example, the patient's respiration, heartbeat, or other movement may indicate a flow vector different from the expected flow vector produced by the camera's motion. However, by averaging out the motion a net flow vector may be determined and used for further analysis of the imaging system and the determination of defects or contamination thereof. Averaging may be determined dynamically (e.g., number of image frames for a motion to occur and return to its initially observed position) or previously determined, such as to accommodate known or anticipated motion (e.g., one to three seconds to average heart rate-induced motion, three to ten seconds to average respiratory-induced motion, etc.). Additionally or alternatively, there image motions, such as the camera capturing another surgical instrument, tissue moving in response to the endoscope or other procedure, etc. may be selectively silenced (e.g., for a period of time when there are either a vast number of dissimilar flow vectors, a time when a procedure is known to cause unreliable imaging, when an identified object (e.g., surgical instrument) is identified as the source of the vector) and/or averaged.

Further steps can include, for example the acquisition of image data by the optical system, generating an output signal, controlling a display device by means of a control signal, and the like.

In another embodiment, a computer program product is disclosed that comprises executable program code that is configured to carry out the method according to an embodiment of the second aspect of the present invention when executed by a computing device.

In another embodiment, a non-transitory computer-readable data storage medium that comprises executable program code that are disclosed that carry out the method according to an embodiment of the second aspect of the present invention when executed by a computing device.

The non-transitory, computer-readable data storage medium can comprise or consist of any type of computer memory, in particular semiconductor memory (e.g., a solid-state memory). The data storage medium can also comprise or consist of a CD, a DVD, a Blu-ray disk, a USB memory stick or the like. In another embodiment, the non-transitory medium may be embodied as a portion of a shared server, or collection of servers (e.g., “cloud”, array, server farm, etc.)

In another embodiment, a data stream is disclosed comprising executable program code or configured to generate executable program code which is configured to carry out the method according to an embodiment of the second aspect of the present invention when executed by a computing device.

In accordance with certain embodiments, variants or refinements of embodiments, or aspects, the evaluation module is configured to determine at least one of the following states of the optical system on the basis of the at least two identified different image flow vectors: a contamination of the optical system; damage to the optical system; a remaining useful life of the optical system; and/or a degree of functionality of the optical system.

Contamination that may affect the optical system is variously embodied and may include, but is not limited to, stains, lint, or other debris on a lens system of the optical system.

Damage to the optical system can include damage to a lens system of the optical system, such as a scratch, crack, clouding, delamination of coatings, misalignment, foreign matter intrusion (e.g., between optical elements), imager defect (e.g., “dead” pixel of a charged coupled device (CCD)) and/or the like. Damage to the optical system can also include damage to at least one light guide, for example a fracture, a splintering, a strand defect, aging and/or the like.

The degree of functionality can be expressed as a percentage at which the optical system is functional, for example, the percentage at which the optical system can still acquire an image that it would otherwise acquire in an ideal, unimpaired state. The degree of functionality can also be expressed as a percentage of functional pixels out of a total number of pixels available in the ideal, unimpaired state, or the like.

In the evaluation of the determined image flow vectors, to identify the at least one state of the optical system, a threshold value can be provided, in particular a minimum number of identified different image flow vectors which must be exceeded in order for the evaluation module to determine a state of the optical system that represents an impairment. The evaluation module can be configured such that if only a single image flow vector is identified in the optical flow (e.g., determined that all pixels are moving/have moved in the same way), or if a number of different image flow vectors are identified up to a maximum of the provided threshold value, it will conclude that the optical system is in a standard state (e.g. “no impairment” or “100% functionality”).

Alternatively however, no threshold value can be provided (or, equivalently, a threshold value of “1 image flow vector” can be provided), so that the evaluation module concludes that the optical system is in an “impairment present” state when two different image flow vectors are identified, and preferably then (or from the outset) makes a more precise determination of the impairment. It can also be provided that the threshold value of the device can be adjusted by a user, e.g. via a user interface, depending on which application is planned. For an image that is expected to be very static, the threshold could therefore be set lower than for an image that is expected to have high variability.

The acquisition of the current state of the optical system can also include a quantitative classification of the state (in particular if it represents an impairment). For example, in the case of contamination or damage to a lens system of the optical system, a percentage by which the lens system is affected by the contamination or damage and/or a percentage by which an image acquired by the lens system is affected by the contamination or damage can be acquired. In the case of damaged light guides, a percentage of light guides that are damaged of the total number of light guides can be acquired, and so on. The signal generated by the output interface can also include this quantitative classification, such as one or more of the percentages mentioned, in particular in digital form.

The acquisition of the state of the optical system is preferably carried out multiple times, in particular regularly or at least repeatedly. In particular, when even a quantitative classification of the particular state is determined, in this way the evaluation module can record a temporal development of this quantitative classification. On this basis, for example if a threshold value is specified for one or more quantitative classifications, a remaining service life of the optical system can be determined. For example, it can be provided that if x % or more of the light guides and/or x % or more of the surface of the lens system is damaged, the optical system should be classified as “no longer functional,” (e.g., the end of its useful life has been reached).

By continuously determining the quantitative classification with time stamps in each case, a point in time at which the service life of the optical system will end can be extrapolated. On this basis, for example, predictive maintenance can be carried out so that a warning is issued approximately x weeks or months before the extrapolated (or predicted) end of the service life (e.g. via an instrument management system or a display device of the device), indicating that the service life of the optical system will end in x weeks or months. This display can be output continuously and updated dynamically, in a similar way to a vehicle's fuel level indicator.

The output signal generated by the output interface can include an item of information about a predicted end of service life and/or a recommended maintenance or replacement time and can be transmitted by the device according to the invention to, for example, an instrument management system. Based on this, a spare part can be ordered automatically, the production of a spare part can be controlled, and so on.

According to some preferred embodiments, variants or refinements of embodiments, the output interface is further configured to output a request for action to a user to rectify or improve the at least one determined state of the optical system and/or to output a control signal to automatically rectify or improve the at least one determined state of the optical system. The request for action and/or the control signal can be part of the output signal of the output interface or can be different from it.

The request for action can, for example, consist of a graphic display showing the image currently acquired by the optical system, additionally showing the message, “clean the lens system” or the like, or an acoustic warning (in the form of a warning tone or a voice output) indicating the same. To output the request for action, appropriate control signals can be output through the output interface, such as video data signals, audio data signals and the like. In the event of an impairment that cannot be corrected (at least by the current user) according to the determined state of the optical system, the call for action can also include a request for maintenance or even replacement of the optical system.

A control signal for automatically correcting or improving the at least one state can, for example, consist in the fact that in the case of a damaged light guide, the image pixel(s) that would have to be transmitted by this light guide is/are omitted or replaced on the software side, for example by a placeholder or by interpolation from the surrounding image pixels. Determining the state of the optical system can include determining whether to perform such automatic rectification or improvement (for example, if the impairment is aesthetically disturbing but not severe) or not to perform it (for example, if the impairment involves more than x light guides, so that it may no longer be guaranteed that the interpolation will not erase objects in the acquired image).

According to some preferred embodiments, variants or refinements of embodiments, the evaluation module is further configured to determine a speed of a change of at least one determined state of the optical system. The change will usually be a deterioration of the state (e.g., a progressive degradation of the optical system).

As explained above, determining the rate of change can be done in particular in connection with, or based on, a quantitative classification of the particular state. Based on the determined speed of change, an acceleration of the change can, for example, then be determined in order to be able to detect a possible rapid deterioration of the state, for example for predictive maintenance.

According to some embodiments, variants or refinements of embodiments, the evaluation module is configured to carry out the determination of the optical flow, the identification of the at least one image flow vector and/or the determination of the at least one state of the optical system in a normal operation during the runtime of the optical system. The user therefore does not have to explicitly carry out a test mode or the like, but performs out his activity as usual while the evaluation module operates in the background. This also ensures that the state of the optical system is determined with a desired frequency or regularity.

According to some preferred embodiments, variants or refinements of embodiments, the evaluation module is configured to carry out the determination of the optical flow, the identification of the at least one image flow vector and/or the determination of the at least one state of the optical system exclusively (or in addition to a regular execution in the background) in a separate test operation of the optical system. This allows the user to ensure that the optical system is in a problem-free state (or in a known, acceptably impaired state) before performing a surgical intervention or in case of suspicion. During test operation, the evaluation module can optionally provide the user with instructions for carrying out the test operation. The instructions can be given visually (via a display device) or acoustically, as already explained above. The instructions can include instructions such as: “please pan left to right,” “please hold still,” or the like.

In another embodiment, a device for determining a state of an optical system for an endoscope is disclosed, comprising: an input interface configured to receive image data acquired by means of the optical system; a computing device configured to implement at least one evaluation module configured to determine an overall optical flow of the obtained image data, to identify on this basis at least one image flow vector, and, if at least two different image flow vectors have been identified, to determine on this basis at least one state of the optical system; and an output interface which is configured to generate an output signal which comprises an item of information about the determined at least one state of the optical system.

In another embodiment, the evaluation module is configured to determine at least one of the following states of the optical system on the basis of the at least two identified different image flow vectors: a contamination of the optical system; damage to the optical system; a remaining useful life of the optical system; and/or a degree of functionality of the optical system.

In another embodiment, the output interface is further configured to output a request for action to a user to rectify or improve the at least one determined state of the optical system and/or to output a control signal for automatically rectifying or improving the at least one determined state of the optical system.

In another embodiment, the evaluation module is further configured to determine a speed of a change of at least one determined state of the optical system.

In another embodiment, the evaluation module is further configured to implement predictive maintenance on the basis of the determined rate of change of the at least one determined state of the optical system.

In another embodiment, the evaluation module is configured to carry out the determination of the optical flow, the identification of the at least one image flow vector and/or the determination of the at least one state of the optical system in normal operation during the runtime of the optical system.

In another embodiment, the evaluation module is configured to carry out the determination of the optical flow, the identification of the at least one image flow vector and/or the determination of the at least one state of the optical system exclusively in a separate test operation of the optical system, wherein instructions for carrying out the test operation are optionally provided to a user by the evaluation module.

In another embodiment, a computer-implemented method for determining a state of an optical system for an endoscope is disclosed, comprising: obtaining image data acquired by the optical system; determining an overall optical flow in the obtained image data; identifying at least one image flow vector in the determined optical flow; and if at least two different image flow vectors have been identified: determining, on the basis of the at least two different identified image flow vectors, at least one state of the optical system.

In another embodiment, executable program code that is designed to carry out the methods when executed by a computing device is disclosed.

In another embodiment, a computer-readable non-volatile data storage medium, comprising executable program code that is designed to carry out the methods when executed by a computing device.

Further advantageous variants, options, embodiments and modifications result from the following figures and the associated detailed description, as well as from the claims. It should be understood, however, that the detailed description and specific examples, while they do indicate preferred embodiments of the invention, are given by way of illustration only, since various changes and modifications within the scope of the invention will be apparent to those skilled in the art.

### BRIEF DESCRIPTION OF THE FIGURES

Individual embodiments of the present disclosure will be explained in detail with reference to the following figures. The components in the drawings are not necessarily to scale, but are provided in order to illustrate the principles of the present invention. Parts in the different figures that correspond to the same elements or method steps have been given the same reference signs in the figures. The numbering of method steps initially serves only to distinguish them and does not necessarily imply a corresponding order, although in one variant the steps are carried out in the order in which they are numbered. A plurality of steps can also be carried out in overlapping fashion or simultaneously. In the figures:

FIG. 1 illustrates a schematic block diagram for explaining a device in accordance with embodiments of the present disclosure;

FIG. 2 schematically shows an optical system for an endoscope in accordance with embodiments of the present disclosure;

FIG. 3a to FIG. 3c schematically shows a sequence of image data as recorded by the optical system in FIG. 2 in accordance with embodiments of the present disclosure;

FIG. 4 shows schematic image flow vectors based on the temporal sequence of the image data in FIG. 3a to FIG. 3c in accordance with embodiments of the present disclosure;

FIG. 5 shows a schematic flow diagram in accordance with embodiments of the present disclosure;

FIG. 6 shows a schematic block diagram of a computer program product in accordance with embodiments of the present disclosure; and

FIG. 7 shows a schematic block diagram of a non-volatile computer-readable data storage medium in accordance with embodiments of the present disclosure.

### DETAILED DESCRIPTION OF THE FIGURES

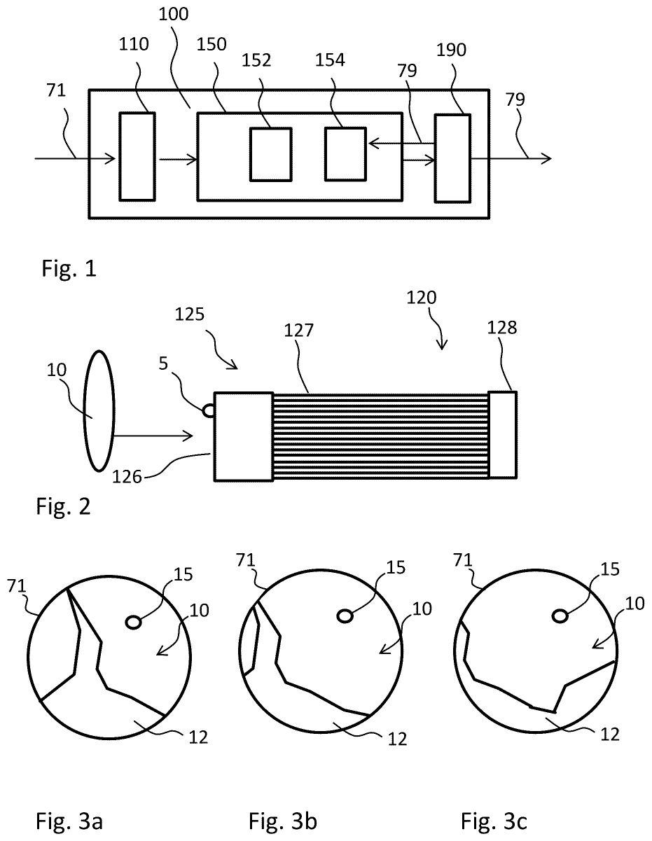

FIG. 1 shows a schematic block diagram for explaining an apparatus 100 according to an embodiment of the present invention, (e.g., an apparatus 100 for determining a state of an optical system for an endoscope). FIG. 1 is described in more detail below.

FIG. 2 schematically shows such an optical system 125 for an endoscope 120 (only partially shown). The optical system 125 comprises in particular a lens system 126 and a plurality of light guides 127, such as glass fibers, which transmit an image 10 acquired at the lens system 126, for example pixel by pixel, for example, to a photosensor array 128. The photosensor array 128 can be part of the optical system 125 or can be part of the remaining part of the endoscope 120. The optical system 125 can be replaceable (e.g., the endoscope 120 can be designed such that the optical system 125 can be replaced if it has (excessive) impairments). The device 100 can include an optical system 125 or an endoscope 120 or can be formed separately therefrom. If the device 100 comprises an endoscope 120, it can also be referred to as an endoscope 120 with integrated state detection.

Returning to FIG. 1, it can be seen there that the device 100 has an input interface 110 which is designed or configured to receive images 10 acquired by the optical system 125, or more precisely: digital image data 71 based thereon.

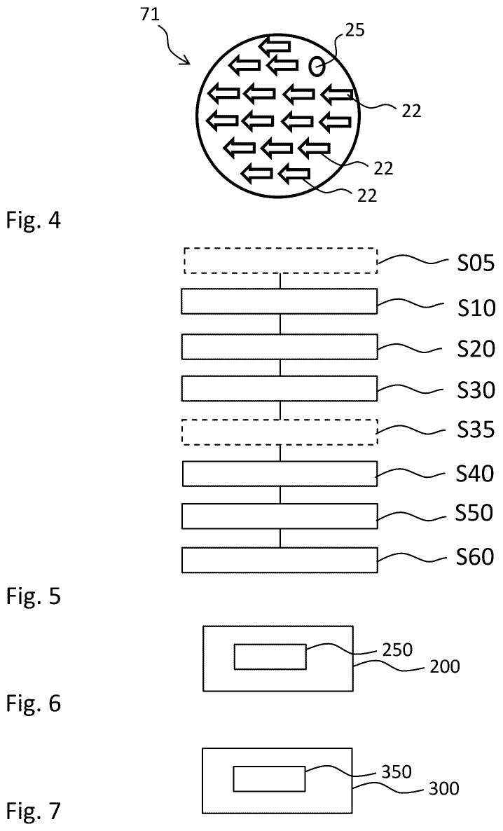

The device 100 also has a computing device 150 which implements at least one evaluation module 152. The function of the evaluation module 152 is explained in more detail below with reference to FIGS. 3a, 3b, 3c and 4. As an example, the situation chosen for the explanation is that the state of the optical system 125 is an impairment of the optical system 125, specifically a contamination of the optical system 125. FIG. 2 indicates that there is such a contamination 5 on the lens system 126, for example a dried-on drop of liquid or the like.

FIG. 3a to FIG. 3c schematically show image data 71 acquired by the lens system 126 of the optical system 125 while the endoscope 120 is being moved to the right (with respect to the figures page). The image 10 contains a structure 12 of interest, for example human tissue of a patient or the like. In the acquired image data 71, in addition to the actual image 10 with the structure 12 of interest, an image artifact 15 is also visible, which is not part of the acquired scenario but is solely due to the state of the optical system 125, namely the contamination 5 on the lens system 126.

If the endoscope 120, or more precisely, the image acquisition cone of the optical system 125, is moved to the right, as shown step by step in FIG. 3b and FIG. 3c, the structure 12 of interest in the image data 71 appears to shift to the left, while the image artifact 15 remains in its place.

The evaluation module 152 is designed and configured to determine an overall optical flow (or main optical flow) of the obtained image data 71 and, based thereon, to identify at least one image flow vector, in particular a main (image flow) vector or dominant optical image flow vector.

FIG. 4 schematically shows possible image flow vectors 22, 25 that the evaluation module 152 was able to identify based on the image data 71 shown in FIGS. 3a to 3c. Known methods of video processing can be used to determine the optical flow. Typically, a plurality of image flow vectors 22, 25 will be determined, for example for each pixel, for each structure 12, 15 recognized in the image data 71, or the like. For the sake of clarity, only a few image flow vectors 22 are shown in FIG. 4.

FIG. 4 illustrates that due to the movement of the endoscope 120, a leftward image flow vector 22 is determined by the evaluation module 152 for most, but not all image points or pixels of the image data 71, and always the same (or with deviations only within an error tolerance or a predefined tolerance threshold). If the optical system 125 is moved as a whole and no other movement occurs in the image 10, the agreement of all determined image flow vectors 22 represents the normal case (or target case). In this case, a global image flow would also be present or determinable by the evaluation module 152.

In the present case, a second image flow vector 25 is also determined, which is different from the image flow vectors 22 and is based on the image artifact 15. This is determined here as the zero vector, since the image artifact 15 does not move with respect to the optical system, and is marked with an ellipse shape in FIG. 4 for the sake of clarity.

The evaluation module 152 is now further designed and configured to determine at least one state of the optical system 125 based on this if (as in FIG. 4) at least two different image flow vectors 22, 25 had been identified (optionally, the presence of a global image flow is also determined).

However, threshold values can be set accordingly. For example, it is not unusual for something to move in the actual image 10, such as an instrument or an organ. For this reason, it can be provided that the evaluation module 152 only determines at least one state of the optical system 125 if more than Y % of the ascertained image flow vectors 22, 25 are equal and non-vanishing (i.e. a global image flow is present), for example more than 40%, more than 50%, more than 60%, more than 70%, more than 80%, more than 90%, more than 90%, more than 95%, or more than 98%.

In this case, it can be concluded that it is not individual objects in the image 10 that are moving, but that a pivoting or movement of the endoscope 120 (or at least of the optical system 125) has taken place (e.g., a large-scale image change), and thus a plurality of different image flow vectors 22, 25 actually indicate (e.g., display), an impaired state of the optical system 125.

In various variants, it can either be provided that a state of the optical system 125 is determined by the evaluation module 152 only when a global image flow is present, or alternatively that the state is always determined, or always when more than two image flow vectors are present, but the presence of a global image flow is taken into account when determining the state.

Additionally or alternatively, it can also be provided that the determination of the image flow vectors 22, 25 takes place over a prespecified or adjustable minimum period of time.

To specifically determine the state of the optical system 125, the evaluation module 152 can use various methods. The information about the presence of, for example, zero vectors in a global image flow is an indication of non-functional (or unreliable) pixels. The shape or arrangement of such pixels or clusters of pixels can already provide an indication of the type of impairment. The evaluation module 152 can thus be equipped with rules that deduce the type of impairment on the basis of the geometric shape or arrangement of pixels or clusters of pixels with zero vectors in the global image flow. For example, an elongated cluster may indicate a scratch in the lens system 126, a round or elliptical cluster may indicate a stain on the lens system 126, and a round and sharp cluster may indicate an impact in the lens system 126. A single non-functional pixel may indicate a broken strand among the light guides 127.

The evaluation of the shape and/or arrangement of non-functional pixels or clusters of non-functional pixels can be supplemented by a content-related and/or quantitative image evaluation. For example, in the case of a broken strand, it is often the case that the non-functional pixel is surrounded by a “halo” of pixels having limited functionality, which can be determined by quantitative image evaluation and taken into account when determining the state.

A plurality of image flow vectors 22, 25 of different sizes and directions could indicate smoke propagation or a streak and thus not an impaired state of the optical system 125.

Alternatively or additionally, a determination of the type of impairment, as part of determining the state of the optical system 125, can also be carried out by means of image difference formation. For this purpose, the difference between the most recent image data 71 and older image data 71 from an image stream sequence of image data 71, or between the most recent image data 71 and a virtual background, can be determined. The virtual background can be created, for example, by averaging the N last image data 71 from an image stream sequence.

The evaluation module 152 thus can also determine the type of impairment by means of a background difference analysis and/or a model sequence difference analysis. Both techniques are known in the prior art. In particular, the position and size of defects in the optical system 125, in particular of the lens system 126 and/or the light guides 127, can be determined.

Depending on the specific application, the determinable states can be defined differently. For example, in a first variant, a state can be: “Defect in pixels A-B, contamination of pixels C-D, fracture of strands E-F,” while in a second variant the same situation can be expressed by three different states 1)-3):
State 1): Defect in pixels A-B
State 2): Contamination of pixels C-D
State 3): Fracture of strands E-F.

The device 100 also has an output interface 190 which is configured to generate an output signal 79 which comprises at least one item of information about the determined at least one state of the optical system 125. In a simple case, the output signal 79 may merely indicate that an impairment is present so that a user can inspect the optical system 125 at the next opportunity. Alternatively, one of the variants or alternatives described above may be provided, according to which the output interface 190 can output a request for action and/or a control signal for automatically rectifying or improving the at least one determined state of the optical system 125, either as the output signal 79, as part of the output signal 79, or in addition thereto. In the case of a state with multiple impairments, or a plurality of determined states each with different impairments, the output signal 79 can of course be adapted accordingly to include an item of information, a request for action, a control signal, etc., for each impairment.

In the case described here with reference to FIGS. 2-4, for example, a display device (such as a display or a touchscreen) could be controlled to display the message, “Clean the lens system” or the like in addition to the image data 71 acquired by the optical system 125. Alternatively, an acoustic output device (such as a loudspeaker or headphones) could be controlled to emit an acoustic warning signal, e.g. a warning tone or a voice output “Warning: clean the lens system” or the like.

If, as also explained above, a remaining useful life (or, equivalently, a date for the estimated end of the useful life, or a number of remaining uses of the optical system 125) is determined, this can also be displayed by the display device, in particular also permanently and/or regularly and/or dynamically updated.

The image processing of the image data 71 acquired by the optical system 125 is usually performed in a device referred to as a “camera controller.” Accordingly, it is advantageous if the device 100 according to the invention comprises such a camera controller or is integrated into such a camera controller. Parts of the evaluation module 152 can then be carried out, for example by video processing processes that are already running in the camera controller. In addition, the camera controller is usually configured to control a display device for displaying the acquired image data 71 and thus also comprises an output interface which can also perform the tasks of the output interface 190 of the device 100 according to the invention. However, the device 100 can also be implemented entirely or partially remotely, for example through a cloud computing platform.

The device 100 can collect the output signals 79 for a plurality of optical systems 125 as part of an instrument management system. For this purpose, the device 100 can, for example have an instrument management module 154. Each optical system 125 preferably has an individual identifier (e.g. an alphanumeric identification code) by means of which each determined state can be uniquely assigned to the corresponding optical system 125. For example, as already described above, through the instrument management module 154 the evaluation module 152 can thus acquire and store determined quantitative ratings of each determined state of each optical system 125, optionally together with a determined rate of change of the state or of the quantitative rating and/or with a remaining useful life of the corresponding optical system 125 (estimated for example based on the rate of change). The information about the determined states can be output and/or saved in a machine-readable report with predefined fields.

This enables very precise and effective predictive maintenance, since for each optical system 125 it is known at all times whether and to what extent it has impairments and when these (if applicable) have reached or will reach such a large extent that the corresponding optical system 125 must be replaced. The instrument management module 154 can be configured to automatically order or control the corresponding replacement or even the production of a replacement part to mitigate or remedy the impairment.

If the device 100 according to the invention has an instrument management module 154, it is preferred that at least the instrument management module 154, or the entire device 100, is implemented centrally, for example by a server of a medical institution (e.g., hospital, research facility, doctor's office, etc.), by a cloud computing platform or the like, so that a large amount of image data 71 from a large number of different optical systems 125 can be easily transmitted to the device 100 and evaluated by it.

FIG. 5 shows a schematic flow diagram for explaining a method according to a further embodiment of the present invention. The method according to the invention can be carried out in particular by means of the device 100 according to the invention, but also separately therefrom. Accordingly, the method according to the invention is adaptable according to all options, variants, developments and refinements described with reference to the device according to the invention, in particular in the foregoing with reference to FIGS. 1-4, and vice versa.

In a step S10, image data 71 that were acquired by the optical system 125 are obtained. This can be done for example as already described above with reference to the input interface 110. The method can optionally also comprise a preceding step S05 of acquisition of image data 71 by the optical system 125.

In a step S20, an overall optical flow (or main optical flow) is determined in the obtained image data 71, in particular as described above with reference to the evaluation module 152 and FIGS. 3a to 4. For example, typical video processing can be carried out for this purpose.

In a step S30, at least one image flow vector 22, 25 is identified in the determined optical flow, in particular as described above with reference to the evaluation module 152 and FIG. 4. The at least one image flow vector 22, 25 determined (or to be determined) can in particular be a main (image flow) vector or dominant optical image flow vector.

In an optional step S35, it is determined whether a global image flow is present, as has also been explained in detail above. The presence of a global image flow can be used as an optional additional necessary criterion for determining a state of the optical system 125, or for determining an impaired state of the optical system 125, or the like.

If at least two different image flow vectors 22, 25 were identified in step S30 (optionally: and additionally the presence of a global image flow was determined in step S35), then in a step S40 at least one state of the optical system 125 is determined based on the at least 2 different identified image flow vectors 22, 25, for example as explained above with reference to the evaluation module 152 or generally with reference to the invention.

In a step S50, an output signal 79 can be output based on the at least one determined state, for example as explained above with reference to the output interface 190. The output signal 79 contains at least one item of information about the at least one determined state, optionally also about a quantitative classification of the at least one determined state, and can in particular comprise a request for action and/or a control signal.

In a step S60, an indication device (e.g. a display device or an acoustic output device) can be controlled by means of such a control signal to inform a user about the at least one determined state of the optical system 125, and to visually display and/or acoustically communicate an instruction to the user (e.g. “Clean the lens system”).

FIG. 6 shows a schematic block diagram of a computer program product 200 according to an embodiment of the third aspect of the present invention. The computer program product 200 comprises executable program code 250 that is designed to carry out the method according to an embodiment of the present invention, for example according to FIG. 3 to FIG. 5, when it is executed (e.g. by a computing device).

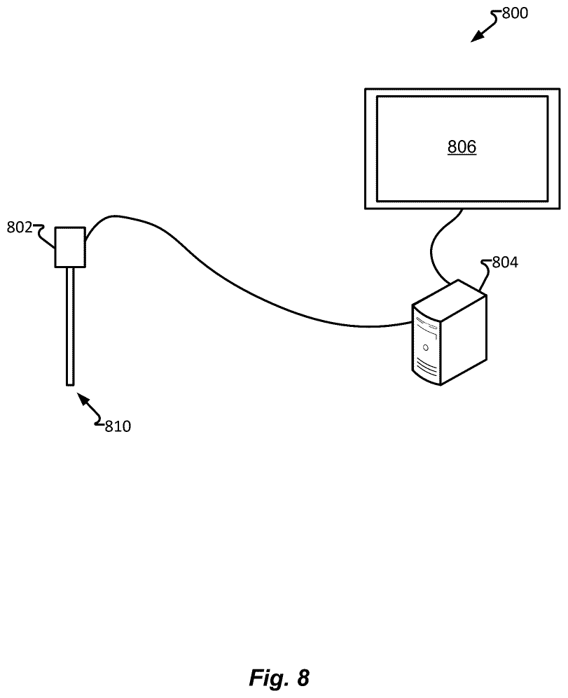

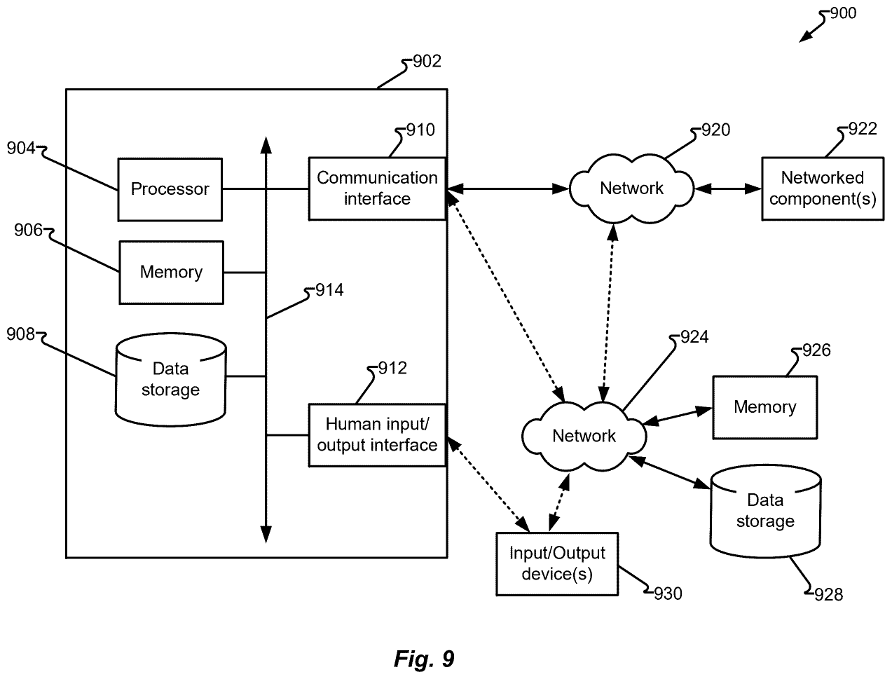

FIG. 7 shows a schematic block diagram of a non-volatile computer-readable data storage medium 300 according to an embodiment of the present invention. The data storage medium 300 comprises executable program code 350 that is designed to carry out the method according to an embodiment of the present invention, for example according to FIG. 3 to FIG. 5, when it is executed (e.g. by a computing device).

The non-volatile computer-readable data storage medium 300 can, for example, be formed as or have a semiconductor memory (e.g., an SSD memory chip). The data storage medium 300 can also comprise or consist of a CD, DVD, Blu-ray or a magnetic storage device.

FIG. 8 depicts system 800 in accordance with embodiments of the present disclosure. In one embodiment, endoscope 802 comprises optical system 810. Optical system 810 may further comprise light-transmitting components, such as fiber bundles, light tubes, etc. In other embodiments, optical system 810 comprises an imaging device, such as a charged coupled device (CCD), or other imaging component receiving light and converting the light to encoded electrical signals for processing by a portion endoscope 802, computer 804, and or other component.

Due to use or damage, optical system 810 may be in one of a number of states determined by the number of image flow vectors. In an unimpaired state the image flow vector is a global image flow, such as when all points imaged move in a common manner. In an impaired state, one or more points imaged do not move in a common manner with one or nearly all (e.g., global less the one or more points imaged that are not moving in the common manner) vectors.

In another embodiment, a computing device, such as computer 804, determines the number of different image flow vectors, that is, a count of the vectors that do not move in common with the majority of image flow vectors or, alternatively, the vector(s) that do not move in common with the image flow vectors that are associated with the largest portion if the image data (e.g., number of pixels, number of imaged features, etc.). An output device, such as display 806 may present indicum of the state, such as a text message, recorded or generated speech from a speaker, status light, etc.

In another embodiment, computer 804 determines if the state is an impaired state further comprises determining if the impaired state is due to contamination of the optical system or damage to the optical system. Damage may be identified by image information, such as jagged lines of a crack, “dead” pixels than never change value, an areas of the image information that cannot be focused together, color (e.g., delamination of tinted, such as blue, green, or purple, lens coatings), optical artifacts (e.g., glare, halo, rainbows, glint, etc.), and so on. As the optical system may comprise more than lenses, such as fiber bundles that carry light to an imaging component, the fibers may become damaged resulting in areas of the image information that are darker/lighter than other areas, pixels that display inconsistent image, such as a straight line being imaged being presented by the image information as a segmented or non-straight line, or pixels that display inconsistent luminosity.

While an optical system operating nominally will have a single, global flow vector, the presence of a second image flow vector may, or may not, indicate the optical system is in an impaired/unimpaired state. For example, if half the image information is associated with one image flow vector and the other half is associated with another image flow vector, the optical system may be determined to be in an impaired state. The threshold of the number, or sizes of the number, of image flow vectors may be dynamically determine or previously determined. For example, an optical system may have five different flow vectors and, due to a surgeons input, sets the threshold higher (e.g., six, ten, etc.) and only if the resulting dynamic threshold is exceeded will the state be set to impaired. Similarly, the area and position of a second image flow vector (the global image flow vector being the first) may not be a factor, if it is below a static threshold, and therefore be in an unimpaired state. However, if the size is above a static threshold, the surgeon may find no issue (e.g., the contamination is on the edge of the image) and dynamically raise the threshold. Similarly, computer 804 may automatically alter the threshold, such as due to the location of the contamination causing the image flow vector (e.g., in the middle of the image, less tolerance is permitted; on the fringe of the image, more tolerance is permitted). Degradation over time may be extrapolated to predict a time in which the number and/or size of the image flow vectors will become greater than a threshold and report such an occurrence as impaired state with the time the impairment is determined to occur. Indicum of the state, such as the rate and/or time in which the unimpaired state is likely to become an impaired state, may then be presented, such a via display 806.

In another embodiment, two or more image flow vectors are observed by computer 804. The largest, being the global image flow vector, is not considered. The next image flow vector may have correction applied (e.g., pixel averaging, disabling, overwriting, extrapolating image data from surrounding pixels, apply a color correction, etc.) such that the defect is negated. As a result, an otherwise impaired state may then be set to an unimpaired state. Such a remediation may be automatically applied and/or initiated, such as by computer 804. In another embodiment, an indicium of the defect may be presented (e.g., “clean the lens,”) to cause a cleaning operation to be automatically, when available, or manually applied.

FIG. 9 depicts system 900 in accordance with embodiments of the present disclosure. In one embodiment, one or more of endoscope 802, computer 804, and display 806 are each embodied as device 902. Computing device 150 is embodied as process 904, in one embodiment, and as device 902, in another embodiment.

While the embodiments herein are primarily directed to discrete and intercommunicating components, specifically, endoscope 802, computer 804, and display 806, it should be appreciated that in other embodiments, and combinations of two or more of the forgoing may be made into a common device. Additionally or alternatively, one or more of the forgoing components may be co-embodied with another component (not shown) and/or separated into two or more discrete components.

Processor 904 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via bus 914, execute instructions, and output data, again such as via bus 914.

In addition to the components of processor 904, device 902 may utilize memory 906 and/or data storage 908 for the storage of accessible data, such as instructions, values, etc. Additionally or alternatively, processor 904 may utilize memory 926 and/or data storage 928 for data storage. In one embodiment, input interface 110 and/or output interface 190 are embodied as embodied as instantiations of communication interface 910 and/or human input/output interface 912.

Communication interface 910 facilitates communication with components, such as processor 904 via bus 914 with components not accessible via bus 914. Communication interface 910 may be embodied as a network port, card, cable, card, radio frequency communication component, infrared communication component, or other configured hardware device. Additionally, or alternatively, input/output interface 912 connects to one or more interface components to receive and/or present information (e.g., instructions, data, values, etc.) to and/or from a human and/or electronic device. Examples of input/output devices 930 that may be connected to the input/output interface 912 include, but are not limited to, keyboard, mouse, trackball, printers, displays, sensor, switch, relay, speakers, etc. In another embodiment, communication interface 910 may comprise, or be comprised by, input/output interface 912. Communication interface 910 may be configured to communicate directly with a networked component or utilize one or more networks, such as network 920 and/or network 924.

Network 920 may be a wired network (e.g., Ethernet), wireless (e.g., WiFi, Bluetooth, cellular, etc.) network, or combination thereof and enable device 902 to communicate with network component(s) 922.

Additionally, or alternatively, one or more other networks may be utilized. For example, network 924 may comprise a second network, which may facilitate communication with components utilized by device 902. For example, network 924 may be an internal network to a medical facility utilizing endoscope 802 whereby components are trusted (or at least more so) than networked components 922, which may be connected to network 920 comprising a public network (e.g., Internet) that may not be as trusted. Components attached to network 924 may include memory 926, data storage 928, input/output device(s) 930, and/or other components that may be accessible to processor 904. For example, memory 926 and/or data storage 928 may supplement or supplant memory 906 and/or data storage 908 entirely or for a particular task or purpose. For example, memory 926 and/or data storage 928 may be an external data repository (e.g., server farm, array, “cloud,” etc.) and allow device 902, and/or other devices, to access data thereon. Similarly, input/output device(s) 930 may be accessed by processor 904 via input/output interface 912 and/or via communication interface 910 either directly, via network 924, via network 920 alone (not shown), or via networks 924 and 920.

It should be appreciated that computer-readable data may be sent, received, stored, processed, and presented by a variety of components. It should also be appreciated that components illustrated may control other components, whether illustrated herein or otherwise. For example, one input/output device 930 may be a router, switch, port, or other communication component such that a particular output of processor 904 enables (or disables) input/output device 930, which may be associated with network 920 and/or network 924, to allow (or disallow) communications between two or more nodes on network 920 and/or network 924. For example, multiple endoscopes 802 may be in use and under common control of a particular device 902. In such an embodiment, one endoscope may be embodied as input/output device 930 and another endoscope embodied by another input/output device 930. One of ordinary skill in the art will appreciate that other communication equipment may be utilized, in addition or as an alternative, to those described herein without departing from the scope of the embodiments.

The foregoing description of the disclosed embodiments contains examples of possible implementations that are described in order to enable a person skilled in the art to produce or use the present invention. Various variations and modifications of these embodiments will be readily apparent to those skilled in the art after having knowledge of the present invention, and the general principles defined herein may be applied to other embodiments without departing from the scope of the present disclosure.

The present invention is thus not intended to be limited to the specific embodiments shown herein, but is to be accorded the broadest scope consistent with the principles and novel features disclosed herein. For this reason, the present invention is to be limited only in accordance with the following claims.

What is claimed is:

1. A system for determining a state of an optical system of an endoscope, comprising:
an input interface;
a computing device; and
an output interface; and
wherein:
the input interface receives image data acquired by the optical system;
the computing device determines the number of different image flow vectors from the image data and, when the number of different image flow vectors is one, sets the state to an unimpaired state and, when the number of different image flow vectors is at least two, sets the state to an impaired state; and
the computing device outputs indica of the state via the output interface.

2. The system of claim 1, wherein the computing device determines the state is the impaired state comprising determining at least one of a contamination of the optical system or damage to the optical system

3. The system of claim 2, wherein damage to the optical system further comprises at least one of a useful life of the optical system below a previously determined useful life threshold or a degree of functionality below a previously determined degree of functionality.

4. The system of claim 1, wherein the computing device sets the state to an unimpaired state when the number of different image flow vectors is at least two and the number of different image flow vectors is below a previously determined threshold number of different image flow vectors.

5. The system of claim 1, wherein the computing device sets the state to an unimpaired state when the number of different image flow vectors is at least two and the size of the largest image flow vector that excludes a global image flow vector, as compared to the size of the global image flow vector, is less than a previously determined threshold image flow vector size.

6. The system of claim 5, wherein the number of different image flow vectors is at least three and wherein the size of the largest image flow vector, that excludes the global image flow vector, comprises the size of a sum of a plurality of largest image flow vectors that excludes the global image flow vector.

7. The system of claim 1, wherein the computing device sets the state to an unimpaired state when the number of different image flow vectors is at least two and the ratio of the size of the largest image flow vector that excludes a global image flow vector, as compared to the size of the global image flow vector, is less than a previously determined threshold image flow vector ratio.

8. The system of claim 1, wherein the computing device sets the state to an unimpaired state when the number of different image flow vectors is at least two and, for the largest image flow vector that excludes a global image flow vector, negates a defect associated with the largest image flow vector that excludes the global image flow vector by applying a correction to the image data having the defect.

9. The system of claim 8, wherein the correction comprises at least one of pixel averaging, image interpolation, overwriting, or disabling.

10. The system of claim 1, wherein the output interface is further comprises activating remediation component to automatically remedy a defect associated with the largest image flow vector that excludes the global image flow vector.

11. The system of claim 1, wherein the output interface is further comprises activating, via the output interface, a remediation component comprising presenting indicum of the defect.

12. The system of claim 11, wherein the indicum of the defect further comprises at least one of text, generated speech, tone, light, or alteration of a value in a computer memory.

13. The system of claim 11, wherein output interface presents at least one of the image data and the indicum of the defect.

14. The system of claim 11, wherein:
the computing component further determines a rate of degradation of the optical system; and
wherein the indicum of the defect further comprises indicum of the rate of degradation.

15. A method, comprising:
receiving image data acquired by an optical system;
determining the number of different image flow vectors from the image data and, when the number of different image flow vectors is one, setting the state to an unimpaired state and, when the number of different image flow vectors is at least two, setting the state to an impaired state; and
outputting indica of the state via the output interface.

16. The method of claim 15, wherein determining the state is the impaired state comprising determining at least one of a contamination of the optical system or damage to the optical system

17. The method of claim 16, wherein damage to the optical system further comprises at least one of a useful life of the optical system below a previously determined useful life threshold or a degree of functionality below a previously determined degree of functionality.

18. The method of claim 15, further comprising setting the state to an unimpaired state when the number of different image flow vectors is at least two and the number of different image flow vectors is below a previously determined threshold number of different image flow vectors.

19. The method of claim 15, further comprising setting the state to an unimpaired state when the number of different image flow vectors is at least two and the size of the largest image flow vector that excludes a global image flow vector, as compared to the size of the global image flow vector, is less than a previously determined threshold image flow vector size.

20. An endoscopic system, comprising:
an optical system to receive images of a surgical site of a patient and present the images to medical personnel;
an input interface to receive the images and process the images into image data;
a computing device to process the image data; and
an output interface to output indicum of the image data; and
wherein:
the computing device determines the number of different image flow vectors from the image data and, when the number of different image flow vectors is one, sets the state to an unimpaired state and, when the number of different image flow vectors is at least two, sets the state to an impaired state; and
the computing device causes the output device to output indica of the state.
